(19) United States
(12) Patent Application Publication
(10) Pub. No.: US 2002/0154069 A1
(43) Pub. Date: Oct. 24, 2002

(54) Multi-display apparatus

(75) Inventor: Tadashi Nishio, Iruma-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/119,504

(22) Filed: Apr. 10, 2002

(30) Foreign Application Priority Data
Apr. 18, 2001 (JP) 2001-120240

(51) Int. Cl. G09G 5/00

(52) U.S. Cl. 345/1.1

(57) ABSTRACT

A multi-display apparatus that makes it possible to form a plurality of images on a screen unit 4 and display a single picture image, by carrying a plurality of projection units 3 on an engine unit 2 of an apparatus main body. The projection unit 3 has a projector 28 and a plurality of mirrors 22, 23, and 24 for bending projected light from the projector 28 mounted on a same base plate 25. The engine unit 2 is configured in a shelved structure wherein a plurality of projection units 3 are deployed vertically and horizontally. The positions between the optical systems on the base plate 25 of the projection unit 3 are adjusted beforehand. After adjusting a projected image by the projection unit 3 itself, the base plate 25 of the projection unit 3 is slidden over rail members in the engine unit 2 and secured. The positioning of the projection unit 3 with respect to the engine unit 2 is done with the base plate 25 of the projection unit 3, and therefore fewer positional adjustments in the optical systems will suffice after placing the projection unit 3 in the engine unit 2.

This application claims benefit of Japanese Application No. 2001-120240 filed in Japan on Apr. 18, 2001, the contents of which are incorporated by this reference.

### BACKGROUND OF THE INVENTION

1. Field of the Invention

This invention relates to a multi-display apparatus for displaying an image on a large screen by forming projected images from a plurality of projectors on a screen and connecting them together, and particularly to a multi-display apparatus which is made more compact overall and particularly made thinner in the depth dimension.

2. Description of the Related Art

Conventionally there are multi-display apparatuses for displaying a single image by projecting a plurality of images on a screen using a plurality of projectors, wherewith portions of projected images from adjacent projection units are superimposed, the image data of the superimposed portions are subjected to smoothing processing, and one large image is formed, thereby making the boundaries between adjacent images inconspicuous. Examples of such prior art are indicated in Japanese Unexamined Patent Application Publication No. 4-329009, U.S. Pat. No. 5,956,000, and Japanese Unexamined Patent Application Publication No. 9-326981.

There are also apparatuses the transportability whereof is enhanced by combining a plurality of main casings with one screen, as indicated in Japanese Unexamined Patent Application Publication No. 5-300460.

There are, furthermore, apparatuses wherein boxes into which projectors are built are stacked up, one screen is combined therewith, the box joints are minimized to the extreme, and display quality is enhanced, as indicated in Japanese Unexamined Patent Application Publication No. 8-82854.

Furthermore, Japanese Unexamined Patent Application Publication No. 8-140023 discloses an apparatus in which two or three cabinets having a plurality of projectors mounted thereon are connected to assemble a screen, so that the cost of manufacturing is reduced.

With the conventional examples described above, however, the following problems are encountered.

With the apparatuses indicated in Japanese Unexamined Patent Application Publication No. 4-329009, U.S. Pat. No. 5,956,000, and Japanese Unexamined Patent Application Publication No. 9-326981, seamless images can be realized, but nothing is stated therein concerning making the apparatus compact.

With the apparatus indicated in Japanese Unexamined Patent Application Publication No. 5-300460, the joining with the screen unit is effected by a fitting-in scheme, whereupon, when the screen unit becomes large, the task of attaching or detaching the screen becomes very difficult for one worker. Over many years of use, dust adheres to the inside of the screen and in the optical projection systems, wherefore cleaning tasks are always necessary, but a plurality of workers are needed when cleaning is to be done, which has been a problem. When a malfunction occurs, moreover, either everything including the casing must be replaced, or the casing must be disassembled, resulting in large-scale replacements in units of replacement units, and the replacement operation is time-consuming.

With the apparatus indicated in Japanese Unexamined Patent Application Publication No. 8-82854, it is necessary to impart strength to the boxes in units themselves, whereupon the weight of the individual boxes themselves increases, and a plurality of people are needed at installation time and when replacements are made. The use of a forklift or the like also becomes necessary. When a lower stage box malfunctions, moreover, the higher stage boxes must be removed, thus lengthening the replacement time. This has also been a problem.

With the apparatus indicated in Japanese Unexamined Patent Application Publication No. 8-140023, indication is made on the carrying of a projector, but nothing is stated concerning the arrangement of a reflecting mirror or the like for shortening the distance between the projector and the screen while maintaining the size of the projected image.

### SUMMARY OF THE INVENTION

An object of the present invention is to provide a multi-display apparatus wherewith the necessary projection distance can be secured, and the apparatus can also be made more compact particularly making it thinner in the depth dimension.

A multi-display apparatus according to a first aspect of the invention comprises a projection unit having a projector and a plurality of mirrors for bending projected light from that projector mounted on the same base plate, a shelved structure for deploying a plurality of the projection units, and a screen unit for forming projected images from the plurality of projection units and displaying the resulting image.

In the first aspect of the invention, all of the optical systems are mounted on the same base with the projection unit, wherefore it is easy to effect positional precision between the optical systems. Accordingly, after adjusting the projected image with the projection unit itself, that unit is positioned and mounted on the shelved structure. In other words, because the positioning with the structure that is the main part of the apparatus main body is done with the base plate of the projection unit, it is possible to reduce the number of times of positionally adjusting optical systems after mounting them in the apparatus main body. Compared with structures wherein boxes are stacked up, moreover, weight can be reduced, and replacement operations are made easy.

A plurality of projection units are used, but the projection units may be made with the same configuration, affording the advantage of lower manufacturing costs. Also, because a plurality of mirrors are used in the projection unit to effect structures wherewith projected light is bent, when seeking to make the apparatus main body more compact, particularly making it thinner in the depth dimension, the required projection distance is obtained by the path of light reflected from the plurality of mirrors, making it possible to obtain projected images of the required size for each projection unit.

A multi-display apparatus according to a second aspect of the invention comprises an engine unit having a shelved structure for deploying a plurality of projection units each having a projector and a plurality of mirrors for bending light projected from that projector mounted on the same base plate, a screen unit for forming projected images from the plurality of projection units into a picture image and displaying that picture image, and a base for effecting a positional relationship between the engine unit and the screen unit, and supporting those units, wherein the engine unit, the screen unit, and the base are capable of being separated from each other.

In the second aspect of the invention, in addition to being able to obtain the same working benefits as with the first invention, the engine unit, the screen unit, and the base are capable of being separated from each other, and the engine unit that requires precision for effecting mutual positioning between the plural number of projection units is independent of the base, wherefore a structure is realized so as not to be easily affected by deformations in the base.

### BRIEF DESCRIPTION OF THE DRAWINGS

FIG. 1 is a perspective view of the configuration of a base and an engine unit having a shelved structure mounted therein constituting a multi-display apparatus of one embodiment of the present invention;

FIGS. 2A to 2D are diagrams representing a projection unit 3 carried on the engine unit diagrammed in FIG. 1, with

FIG. 2A being a front view (wherein the guide rails 26 and 27 are omitted),

FIG. 2B being a right side view of the projection unit diagrammed in FIG. 2A,

FIG. 2C being a plan of the projection unit diagrammed in FIG. 2A, and

FIG. 2D being a perspective view of the projection unit;

FIG. 3 is a side view for describing how the projection unit is positioned after it has been slidden on rail members of the engine unit;

FIG. 4 is a plan for describing how the projection unit is positioned after it has been slidden on the rail members of the engine unit;

FIG. 5 is a perspective view for describing how the projection unit is positioned after it has been slidden on the rail members of the engine unit;

FIGS. 6A to 6C are diagrams representing how projection units are carried on the engine unit, with

FIG. 6A being a front view wherein a screen unit 4 has been omitted,

FIG. 6B being a side view of what is diagrammed in FIG. 6A, and

FIG. 6C being a plan view of what is diagrammed in FIG. 6A;

FIG. 7 is a perspective view of the screen unit engaged with and attached to the engine unit;

FIGS. 8A and 8B are diagrams for describing how the projector unit is attached and detached,

FIG. 8A being a front view showing how a projector unit 21 is attached to and detached from the projection unit 3, and

FIG. 8B being a perspective view of the projector unit in FIG. 8A;

FIG. 9 is a diagram for describing the adjustment of the projector unit;

FIGS. 10A to 10C are diagrams for describing the adjustment of a small mirror and a medium mirror,

FIG. 10A being a front view of the projection unit,

FIG. 10B being a perspective view of a small mirror adjustment mechanism, and

FIG. 10C being a perspective view of a medium mirror adjustment mechanism;

FIGS. 11A and 11B are diagrams for describing the adjustment of a large mirror in the horizontal direction,

FIG. 11A being a perspective view of a large mirror adjustment mechanism and

FIG. 11B being a diagram for describing an adjustment operation;

FIGS. 12A to 12C are diagrams for describing the adjustment of the large mirror in the vertical direction,

FIG. 12A being a perspective view of one example of a large mirror gate mechanism,

FIG. 12B being a perspective view of another example of the gate mechanism, and

FIG. 12C being a longitudinal sectional view of the large mirror when secured by the mechanism diagrammed in FIG. 12B;

FIGS. 13A and 13B are plans that show a duct leading exhaust gas from a projector to the outside of the apparatus,

FIG. 13A diagramming a duct receptacle secured to a securing unit in the engine unit after mounting and securing the base plate of the projection unit onto the rail members, and

FIG. 13B diagramming how a duct receptacle in FIG. 13A is made detachable from the engine unit so as not to interfere when the base plate of the projection unit is slidden on the rail members;

FIG. 14 is a diagram representing how three projection units mounted in the uppermost stage of the engine unit are removed in order to reduce the height of a package when shipping;

FIG. 15 is a perspective view of one embodiment of a support member employed when opening and closing a screen unit;

FIG. 16 is a perspective view of another embodiment of the support member employed in the screen unit;

FIGS. 17A and 17B are perspective views of yet another embodiment of a support mechanism employed when opening the screen unit,

FIG. 17A representing an example of supporting a turning end of the screen unit by a small step ladder, and

FIG. 17B representing an example wherein the support member for supporting the turning end of the screen unit is deployed on top of the small step ladder, and support is effected, when the screen unit is opened, the small step ladder is slidden in the screen unit from the turning end of the screen unit;

FIG. 18 is a perspective view of a mechanism for adjusting the amount of light in overlapped portions above and below a projected image;

FIG. 19 is a perspective view of a mechanism for adjusting the amount of light in overlapped portions in left and right of a projected image;

FIG. 20 is a sectional view of a position varying mechanism for a light amount reduction member; and

FIG. 21 is a partial sectional view of a ball plunger used in a variable position adjustment shaft in [the mechanism diagrammed in] FIG. 20.

### DESCRIPTION OF THE PREFERRED EMBODIMENTS

Embodiments of the present invention are now described, making reference to the figures.

In the description which follows, insofar as the arrangement of a plurality of projected images projected on a screen unit of a multi-display apparatus is concerned, it will be sufficient to have two or more rows and two or more columns. In the case of a two-row two-column configuration, for example, one large screen will be configured by four image planes on a screen unit, with two rows in the vertical direction, namely an upper row and a lower row, and two columns in the horizontal direction, namely a left column and a right column, and four projectors will be used so as to correspond therewith. When three rows and three columns are deployed, for example, one large screen will be configured by nine image planes on the screen unit, with three rows in the vertical direction, namely an upper row, middle row, and lower row, and three columns in the horizontal direction, namely a left column, middle column, and right column, and nine projectors will be used so as to correspond therewith. For the projectors here, it is possible to use translucent liquid crystal projectors, reflecting liquid crystal projectors, or DLP projectors that employ digital micromirror devices (DMDS), and the like.

In addition to examples having the same number of image planes in the vertical and horizontal directions, such as two rows and two columns, or three rows and three columns, in a case where different numbers of image planes are arranged between the vertical and horizontal directions, for example in two rows and four columns, or in three rows and nine columns, it is possible to form one large screen from eight or 27 image planes by using eight or 27 projectors, respectively.

In the description which follows, the case of a three-row three-column arrangement is described.

The following description is divided into sections pertaining to the apparatus main body and to the parts thereof.

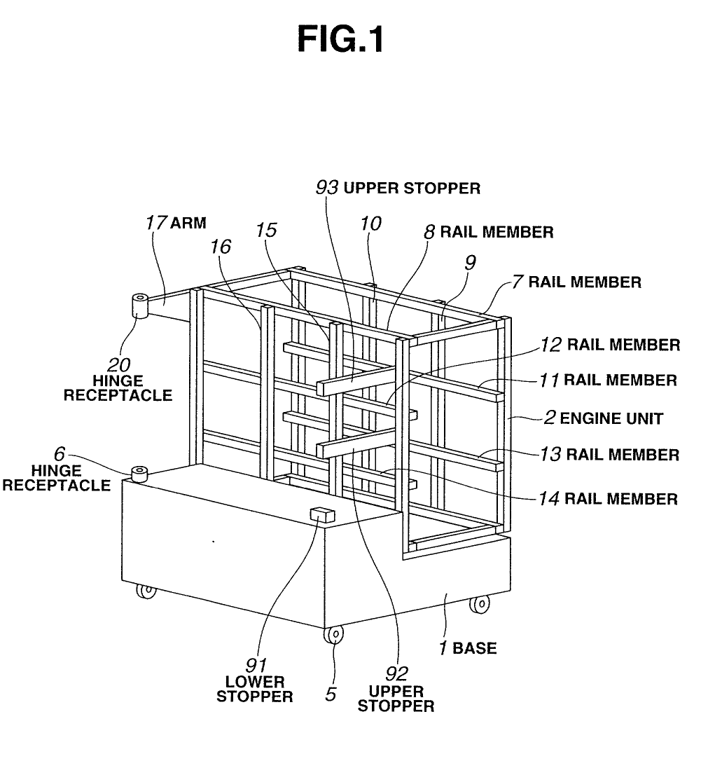

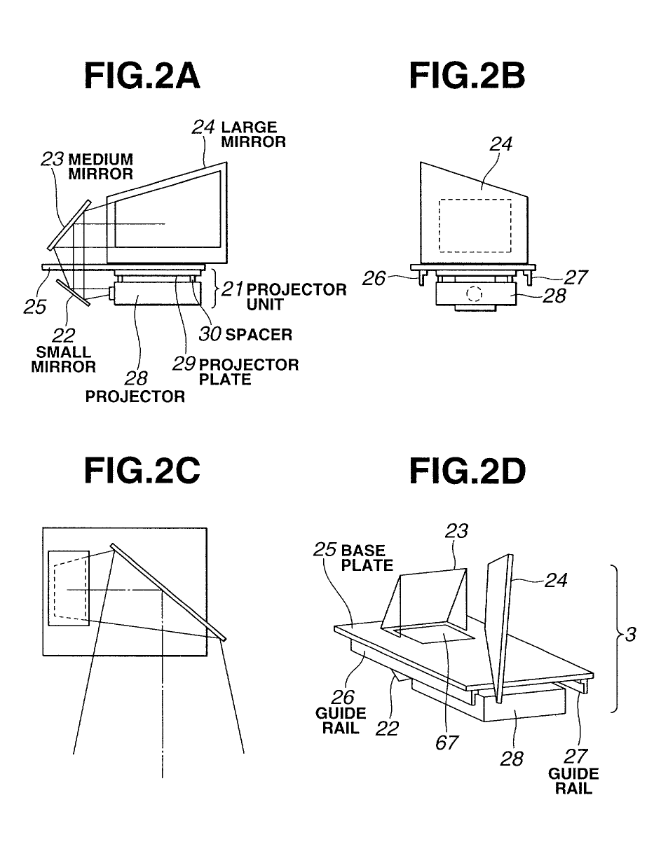

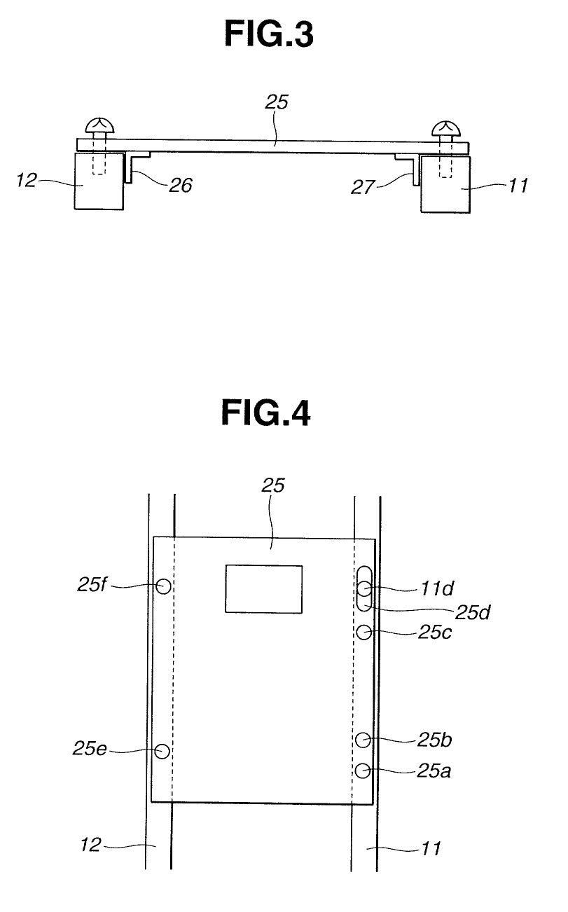

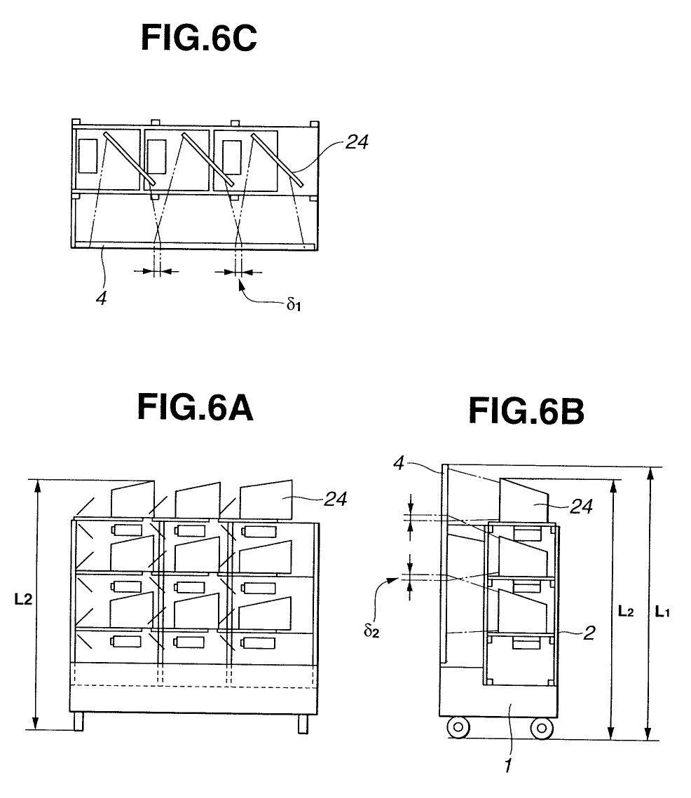

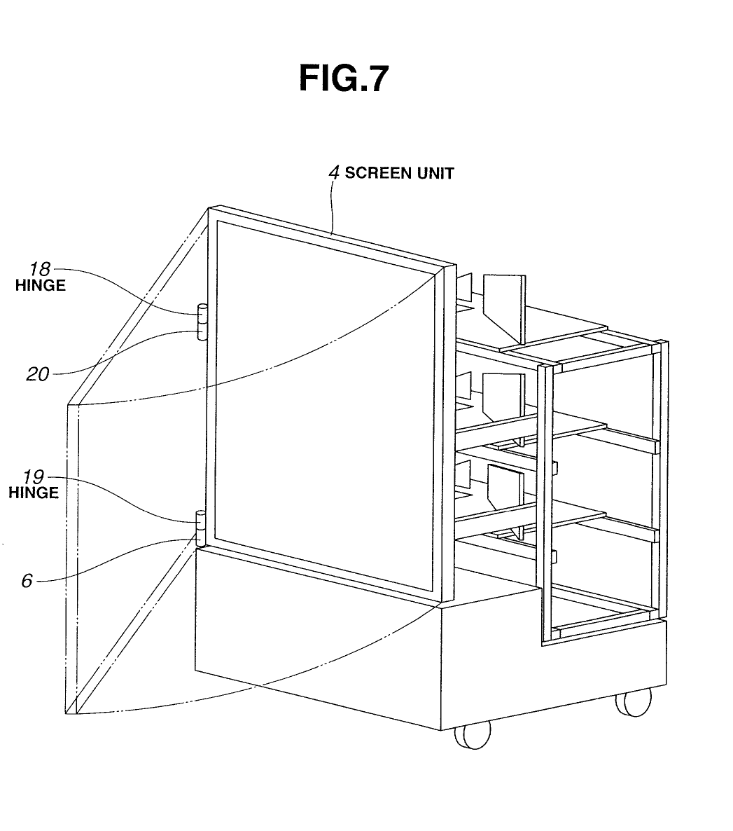

FIG. 1 is a perspective view of the configuration of a base and an engine unit having a shelved structure, mounted on the base, in a multi-display apparatus of one embodiment of the present invention. FIGS. 2A to 2D are diagrams representing a projection unit carried on the engine unit, FIGS. 3 to 5 are diagrams for describing how a projection unit is positioned after it has been slidden on rail members of an engine unit. FIGS. 6A to 6C are diagrams representing how projection units are carried on the engine unit. And FIG. 7 is a perspective view of a screen unit engaged with and attached to the engine unit.

Apparatus Main Body Structure:

The apparatus main body is configured by a base 1 diagrammed in FIG. 1, an engine unit 2 having a shelved structure, mounted on the base 1, a projection unit 3 diagrammed in FIG. 2D carried on the engine unit 2, and a screen unit 4 diagrammed in FIG. 7, engaged with and attached to the engine unit 2.

The base 1, on which are mounted the engine unit 2 and the screen unit 4, is movable by means of casters 5. The base I is formed with substantially a box shape, with the structure thereof as seen from the side formed as a stepped structure having two steps, for example. Within this two-step structure, the engine unit 2 is mounted on the lower step, and the screen unit 4 is mounted on the upper step. In the interior of the base 1, an electrical system including a controller (not shown) is built in, and an image processor for sending image signals to the projection unit 3 is built in. The positional relationship between the engine unit 2 and the screen unit 4 is determined such that a distance between the engine unit 2 and the screen unit 4 is maintained suitably by inserting hinges 18 and 19 provided at one side of the screen unit 4 respectively into a hinge receptacle 20 attached to the tip end of an arm 17 protruding from the engine unit 2 and a hinge receptacle 6 provided at the front on the upper step of the base 1, as diagrammed in FIG. 7, and the weight of the screen unit 4 is supported by resting the lower edge thereof on the surface of the upper step of the base 1. The arm 17, hinge receptacle 20, and hinge receptacle 6 configure positioning members for maintaining the positional relationship between the engine unit 2 and screen unit 4. By making the configuration in this way, the screen unit 4 is able to open by turning about the hinges 18 and 19, as diagrammed in FIG. 7 (indicated by the tow-dotted chain lines in FIG. 7). During maintenance, the screen unit 4 can be opened, enabling cleaning or replacement tasks for the inside of the screen unit 4 or for the project unit 3 inside the engine unit 2.

On the surface of the upper step of the base 1, at the side opposite from the hinge receptacle 6 a lower stopper 91 is provided, and on an upright post at the front side of the engine unit 2, beam-shaped upper stoppers 92 and 93 are deployed so as to project out in a position above the lower stopper 91. By effecting such a structure as this, when projected images are projected on the screen unit 4, the screen unit 4 can be positioned and secured on the base 1 by rotatablly supporting one end of the screen unit 4 by the hinges 18 and 19, and abutting the other end of the screen unit 4 against contact places on the lower stopper 91 and upper stoppers 92 and 93 so as to be latched thereby.

Engine Unit:

The engine unit 2 has eight horizontal beams and eight vertical beams and is fashioned in a shelved structure for carrying a prescribed number (nine in FIG. 1) of projection units 3 diagrammed in FIG. 2D. Of the eight horizontal beams, the beams 7 and 8 at the uppermost row, the beams 11 and 12 at the second row, and the beams 13 and 14 at the third row constitute rail members respectively for sliding the projection units 3. These rail members (7, 8, 11, 12, 13, and 14) are formed so that they protrude toward the inside of the apparatus from the vertical beams.

The projection units 3 are each configured with a projector 28 and a plurality (three in FIG. 2A) of mirrors 22, 23, and 24 for bending the projected light from the projector 28, with the projector and the mirrors being mounted on the same base plate 25, as will be described below (see FIG. 2D). On the lower surface of a base plate 25, guide rails 26 and 27 (see FIG. 2D) are formed with being engaged with the inside of each pairs of the horizontal rail members (7 and 8, 11 and 12, and 13 and 14) of the engine unit 2 so as to guide the projection unit 3 in the direction it should slide in.

The projection units 3 are mounted being slidden horizontally into the pairs of rail members 7 and 8, 11 and 12, and 13 and 14, of the engine unit 2. When that is done, as described earlier, the guide rails 26 and 27 are provided on the bottom of the base plate 25 of the projection unit 3, as diagrammed in FIG. 2D, so as not to become displaced from the rail members 7, 8, 11, 12, 13, and 14, and therefore, when the projection units 3 are slidden and mounted, they are able to securely engage the pairs of rail members.

How the projection unit 3 is positioned on the rail members 11 and 12, after being slidden thereon, is diagrammed in FIGS. 3 to 6. In FIGS. 3 to 5, however, only the base plate 25 in the projection unit 3 is indicated to facilitate the description of the mounted condition. The base plate 25 is mounted so as to span the rail members 11 and 12, as diagrammed in FIGS. 3 and 4, then positioned and secured.

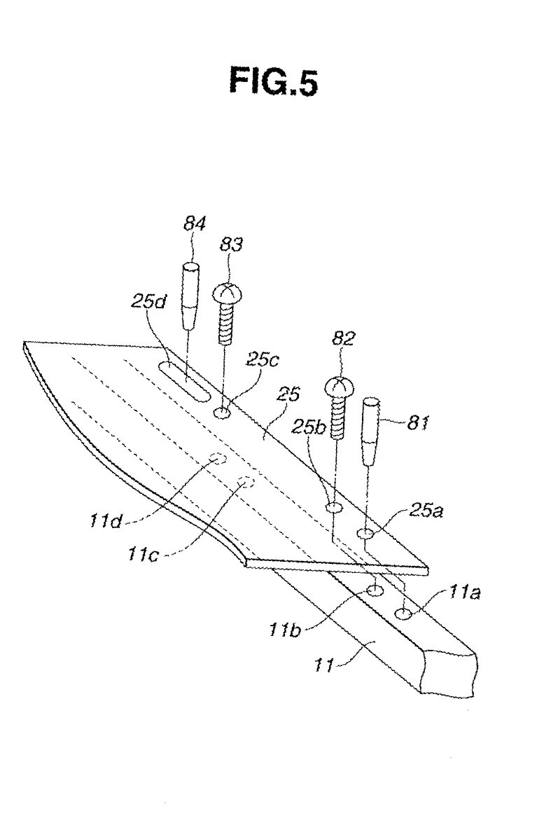

On the upper surface of the rail member 11, as diagrammed in FIG. 5, a positioning hole 11a, screw hole 11b, another screw hole 11c, and another positioning hole 11d are provided for securing the base plate 25 of the projection unit 3. On the upper surface of the rail member 11, positioning holes and screw holes (not shown in either case) are provided, in the numbers necessary, for positioning any other projection units 3. On the base plate 25 of each of projection units mounted on the upper surface of the rail member 12, moreover, screw fastening holes 25e and 25f are provided, as diagrammed in FIG. 4, so as to substantially correspond with the screw holes (not shown) provided in the upper surface of the rail member 12.

When securing the projection unit, first the positioning hole 25a provided on the base plate 25 of the projection unit 3 is aligned with the positioning hole 11a provided in the rail member 11, and the projection unit 3 is positioned on the rail member 11 by inserting a parallel pin 81 that is tapered at the tip into the positioning hole 25a. Then the positioning hole 25d provided in the base plate 25 is aligned with the positioning hole 11d provided in the rail member 11, and, by inserting a parallel pin 84 tapered at the tip into the positioning hole 25d, the projection unit 3 is positionally oriented and positioned so that wobbling in a direction perpendicular to the horizontal is eliminated. The inner diameters of the positioning hole 11a and the positioning hole 25a are defined such that the outer diameter of the parallel pin 81 will accurately fit thereinto, while the positioning hole 25d on the base plate corresponding to the positioning hole 11d is formed as an elongated hole. The elongated positioning hole 25d has, in its width, such a dimension that the outer diameter of the horizontal pin 84 (which is the same as the outer diameter of the horizontal pin 81) will accurately fit thereinto, while the dimension thereof in the longitudinal direction along the rail member 11 exceeds the outer diameter of the horizontal pin 84 and a clearance is created in the hole. After that, the base plate 25 is secured, using screws 82 and 83, to the screw holes 11b and 11c provided in the rail member 11. At that time, one end of the base plate 25 is secured by screw fastening, through the screw fastening holes 25b and 25c provided in the base plate 25 corresponding to the screw holes 11b and 11c in the rail member 11. In the same manner, the other end of the base plate 25 is secured by screw fastening, through screw fastening holes 25e and 25f in the base plate 25 to screw holes (not shown) provided in the rail member 12. Here, high positioning precision is demanded in the positioning hole 11a and the positioning hole 25a, and high positioning precision is also demanded in the positioning hole lid and the short width of the positioning hole 25d, but the machining precision of the screw holes 11b and 11c and of the screw fastening holes 25b and 25c need not be all that high.

The vertical beams 9, 10, 15, and 16 in the middle portion are deployed to the outside of the horizontal beams 7, 8, 11, 12, 13, and 14 so as not to interfere when the projection unit 3 slides on the rail members, and function to suppress deflection in the horizontal beams.

FIGS. 6A to 6C represent how the projection units 3 are mounted in the engine unit 2 in a shelved condition by three columns in the horizontal direction and three rows in the vertical direction. FIG. 6A is a front view, FIG. 6B is a side view of what is diagrammed in FIG. 6B, and FIG. 6C is a plan view of what is diagrammed in FIG. 6A. FIG. 6A represents a condition wherein the screen unit 4 has been omitted, while FIGS. 6B and 6C represent a condition wherein the screen unit 4 is attached.

By configuring the apparatus as described above, the mutual positional distances between the nine projection units 3 mounted in the engine unit 2 as diagrammed in FIG. 6A can be positioned precisely, and both the overlap amount δ1 in the horizontal direction of the projected images on the screen unit 4 indicated in FIG. 6C and the overlap amount δ2 in the vertical direction indicated in FIG. 6B can be made accurate. By matching the projection image plane sizes resulting from each projection unit, it is possible to reduce the amount of correction required in the projected images to form a seamless type of large screen wherein the joining seams are not conspicuous.

Because the base 1 and the engine unit 2 are separated in this manner, the overall height L1 of the apparatus indicated in FIG. 6B can be freely adjusted by changing a height of the base 1 so as to match with a ceiling height at the installation site or with an object of use. This may be done by setting a height of the base 1 beforehand, in the design stage, or a height adjustment function may be imparted internally in the base 1.

The side surfaces, back surface, and top surface (above the projection units at the uppermost row) of the apparatus main body assembled as diagrammed in FIGS. 6A to 6C are configured with exterior member (not shown) deployed as outer walls for keeping out outdoor daylight and dust and the like.

Projection Unit:

The projection unit is described next.

In FIGS. 2A to 2D is diagrammed a projection unit carried on the engine unit described in the following. FIG. 2A is a front view (with the guide rails 26 and 27 omitted), FIG. 2B is a right side view of what is diagrammed in FIG. 2A, FIG. 2c is a plan view of what is diagrammed in FIG. 2A, and FIG. 2D is a perspective view of the projection unit.

The projection unit 3, as diagrammed in FIGS. 2A and FIG. 2D, has a medium mirror 23 and large mirror 24 deployed above the base plate 25, and a projector unit 21, small mirror 22, and guide rails 26 and 27 deployed below the base plate 25. The projector unit 21 comprises the projector 28, a projector plate 29, and spacers 30, with the projector 28 secured to the projector plate 29 via spacers 30. The respective mirrors are arranged such that light projected from the projector 28 is first reflected upward in the vertical direction (that is, toward the base plate) by the small mirror 22, which is the first mirror, positioned at an inclination of approximately 45 degrees with respect to the base plate 25, at the front of the projector 28, passed through a rectangular opening 67 of a prescribed area provided in the base plate 25, and then reflected backward in the horizontal direction by the medium mirror 23, which is the second mirror, inclined approximately 45 degrees with respect to the base plate 25, symmetrically with the small mirror 22 across the boundary of the base plate 25. That light is then reflected toward the screen unit 4 (see FIG. 7) by the large mirror 24, which is the third mirror, erected perpendicularly on the base plate 25 as diagrammed in FIG. 2C, forming a projected image on the screen unit 4 and displaying a picture image.

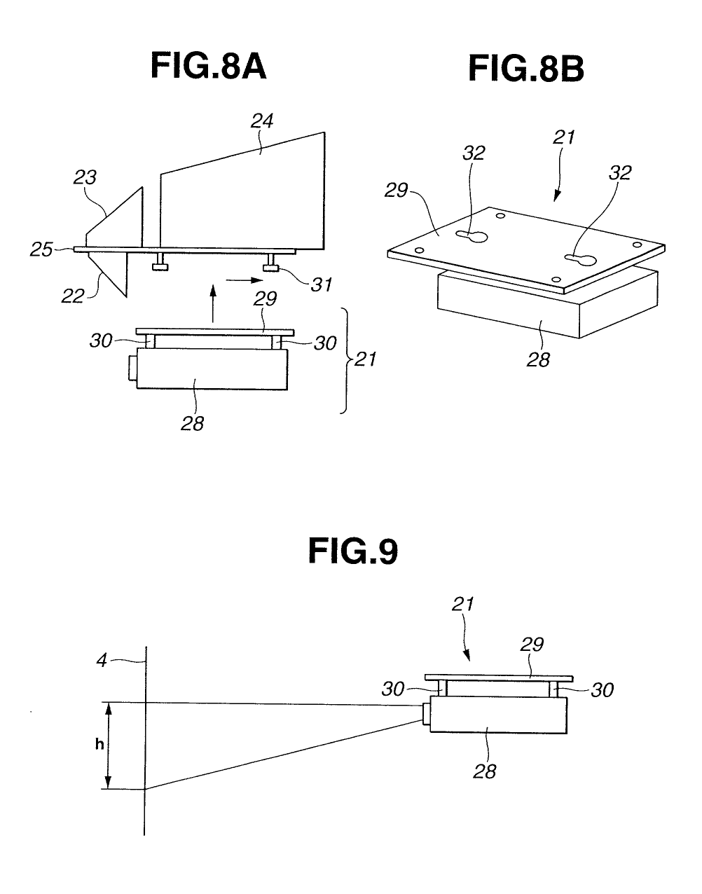

Because the nine projection units 3 carried on the engine unit 2 all have the same shape, they exhibit interchangeability and are easy to handle during production and during maintenance servicing. In the present invention, the projection unit 3 and the projector unit 21 that is a part thereof are treated as replaceable units. The projector unit 21 which is a part of the projection unit 3 has a projector plate 29 that can be freely attached and detached to and from the base plate 25, as is described further below (see FIG. 8A). Also, adjustments are effected in the size of the projection image plane so that interchangeability is maintained (that is, so that the projection images become uniform) even if the projection unit 3 and projector unit 21 are replaced in their respective units. For such an adjustment function, there are focusing functions and zoom functions for changing the magnification. In the projector 28 comprised in the projector unit 21, because mechanical variation arises in the lens system between individual projectors, adjustments are made using a zoom function and/or focusing function so as to effect matching.

Projection Unit Details, Projector Unit Adjustment:

Next, the adjustment of the projector unit and mirrors in the projection unit is described with reference to FIGS. 8A and 8B, 9, 10A to 10C, 11A and 11B, and 12A to 12C.

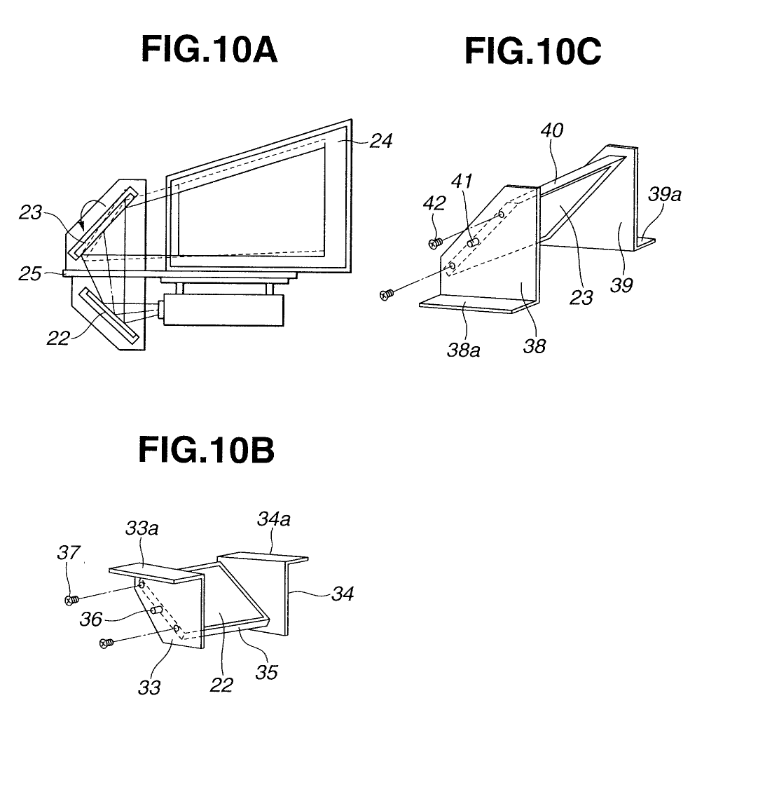

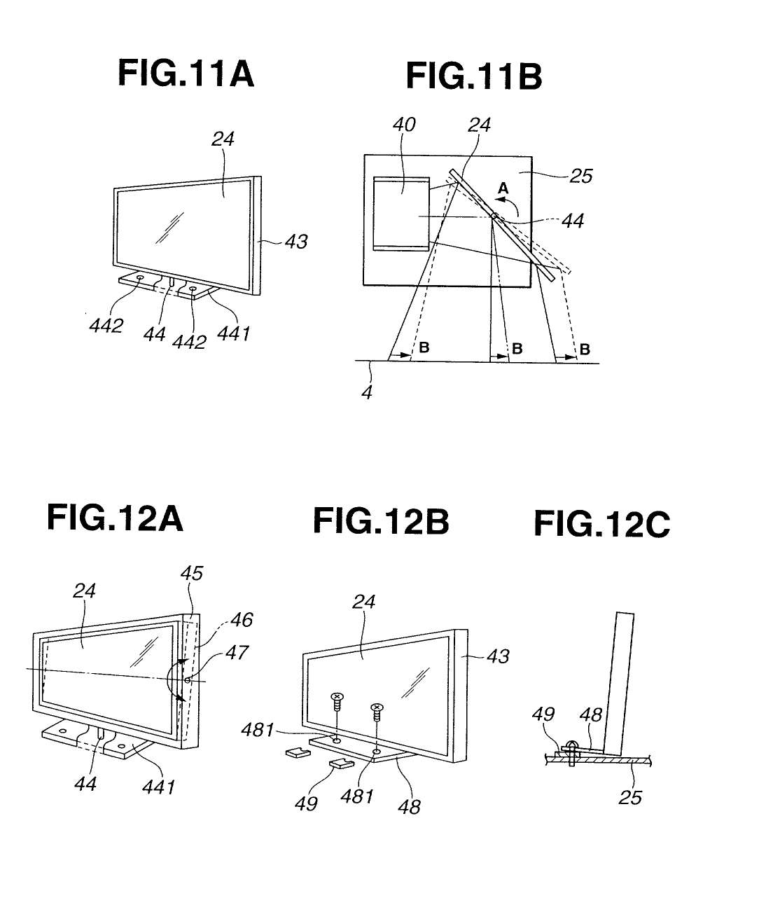

FIGS. 8A and 8B are figures for describing the attachment and detachment of the projector unit. FIG. 9 is a figure for describing the adjustment of the projector unit. FIGS. 10A to 10C are figures for describing the adjustment of the small mirror and medium mirror in the vertical direction. FIGS. 11A and 11B are figures for describing the adjustment of the large mirror in the horizontal direction. And FIGS. 12A to 12C are figures for describing the adjustment of the large mirror in the vertical direction.

The projectors 28 in the projection units 3 will each have different projection positions due to the variation in the lenses and mirror bodies when produced. When a single projector 28 is used, no problems arise, but when a plurality of projectors are deployed together and used as in the present invention, the positional relationships with adjacent projected images become displaced. Thereupon, as diagrammed in FIG. 9, in order that the size and position of the projected image conforms with design objectives, in each individual projector unit 21, the size of the projection image plane thereof is adjusted, using a focus adjustment mechanism and zoom function (not shown) of the projector 28, and the height of the spacers 30 is selected to match the projection position. Instead of the spacers 30, screw mechanisms or the like may be used to effect a stepless adjustment scheme. When adjusting the height, that is done with the spacer 30 in the rear of the projection lens of the projector 28. If the height of the spacer 30 on the projection lens end is changed, the optical axis will be greatly displaced, and the positional relationships between the small mirror 22, medium mirror 23, and large mirror 24 will not be maintained properly.

FIG. 8A is a front view diagramming how the projector unit 21 is attached and detached to and from the projection unit 3. FIG. 8B is a perspective view of the projector unit diagrammed in FIG. 8A.

As diagrammed in FIG. 8A, the projector unit 21, which is a part of the projection unit 3, can be attached and detached to and from that projection unit 3. In the projector plate 29 are formed keyhole-shaped holes 32 as diagrammed in FIG. 8B. In the base plate 25 of the projection unit 3, on the other hand, are provided pins 31 having a flanged head that latch in the keyhole-shaped hole 32 and enable the projector unit 21 to be suspended. When the projector unit 21 is being detached or attached and secured, the worker need not support the projector unit 21, and the attachment/detachment task can be done safely. As to the positioning, positioning precision can be secured by controlling the fitting tolerances between the outer diameter of the pin 31 and the diameter of the small slot in the keyhole-shaped hole 32 into which that outer diameter fits.

Projection Unit Details, Mirror Adjustment:

Next, adjustment mechanisms in the light path along which the projected image projected by the projector unit 21 is guided to the screen unit 4 via the three reflecting mirrors 22, 23, and 24 are described.

In FIGS. 10A to 10C the structures of the small mirror 22 and medium mirror 23 are diagrammed. FIG. 10A is a front view of the projection unit, FIG. 10B is a perspective view of the small mirror adjustment mechanism, and FIG. 10C is a perspective view of the medium mirror adjustment mechanism.

The small mirror 22 is supported by a holder 35 as diagrammed in FIG. 10B. In the holder 35 is deployed a pin 36 that becomes the center of turning, and that pin 36 engages support plates 33 and 34 on either side. The support plates 33 and 34 are positioned and secured to the lower side of the base plate 25 of the projection unit 3 by securing members 33a and 34a. Similarly, the medium mirror 23 is supported by a holder 40 as diagrammed in FIG. 10C. In the holder 40 also is provided a pin 41 that becomes the center of turning, and that pin 41 engages support plates 38 and 39 on either side. The support plates 38 and 39 are positioned and secured to the upper side of the base plate 25 of the projection unit 3 by securing members 38a and 39a. The positional adjustment of the projection image plane on the screen unit 4 in the vertical direction can be performed by these two mirrors 22 and 23. Adjustments can be made easily by turning either of the mirrors about the pins deployed in the holders. After adjusting the angles of the mirrors 22 and 23, the holders 35 and 40 are secured to the support plates 33 and 38 by screws 37 and 42. In this manner, the mirrors 22 and 23 are fixed at the adjusted angles. With a small amount of adjustment in the small mirror 22, the position of the image plane changes greatly in the vertical direction. For ease of adjustment, the position of the image plane can be finely adjusted in the vertical direction with a large amount of mirror adjustment in the medium mirror 23. Accordingly, it is possible to divide the way these are used, so that adjustments are made with the small mirror 22 when the amount of positional adjustment to be made in the image plane in the vertical direction is large, and adjustments are made with the medium mirror 23 when the amount of positional adjustment to be made in the image plane in the vertical direction is very small.

In FIGS. 11A and 11B is diagrammed a structure of the large mirror. FIG. 11A is a perspective view of the large mirror adjustment mechanism, while FIG. 11B is a diagram for describing the adjustment operation.

In FIG. 11A, the large mirror 24 is supported by a holder 43. A pin 44 is deployed substantially in the center of the bottom surface of that holder 43. That pin 44 is fit into a positioning hole (not shown) in the base plate 25, and provides a center about which the large mirror 24 is turned in the horizontal direction to effect positioning. In the holder 43 is also provided a securing plate 441 for securing the large mirror 24 to the base plate 25, and machine screw fastening is effected by machine screw fastening holes 442 provided in this securing plate 441.

The adjusting operation of a projected image on the screen unit 4 in the horizontal direction is now described. As diagrammed in FIG. 11B, when the large mirror 24 is turned in the direction indicated by the arrow A about the pin 44, the projected image on the screen unit 4 can be moved in the direction indicated by the arrow B. The same applies to [moving the projected image in] the reverse direction. There are also times when a gate function will be needed for adjusting distortion which develops in the light path to the large mirror.

In FIGS. 12A to 12C is diagrammed a mechanism for adjusting the large mirror in the vertical direction. FIG. 12A is a perspective view of one example of a large mirror gate mechanism, FIG. 12B is a perspective view of another example of a gate mechanism, and FIG. 12C is a longitudinal sectional view of a secured condition effected by the gate mechanism diagrammed in FIG. 12B.

As an embodiment, there is the method of making the interior of the holder 45 a double-frame structure, as diagrammed in FIG. 12A, and tilting the large mirror 24. With this method, the large mirror 24 is supported by a holder 46, pins 47 are deployed at the left and right of that holder 46, and those pins 47 are inserted into holes in the holder 45 and made the center of turning. As a separate embodiment, there is also the method wherewith, as diagrammed in FIG. 12B, the large mirror 24 is tilted by inserting spacers 49 at machine screw securing positions in a securing plate 48 for securing the holder 43 of the large mirror 24 to the base plate 25, and securing is effected by machine screw fastening in machine screw fastening holes 481 in the securing plate 48.

Installation and Shipping Method:

The method of installing the projection unit 3 in the apparatus main body and the method of packaging and shipping the apparatus main body with projection units 3 carried thereon are described next.

The projection units 3 are slidden from the side on the rail members 7, 8, 11, 12, 13, and 14 and thus mounted in the engine unit 2. When that is done, as described earlier, the projection units 3 are kept from being displaced away from the rail members 7, 8, 11, 12, 13, and 14, when they are mounted, by the guide rails 26 and 27 (see FIG. 2D) deployed in the lower part of the base plates 25 of the projection units 3.

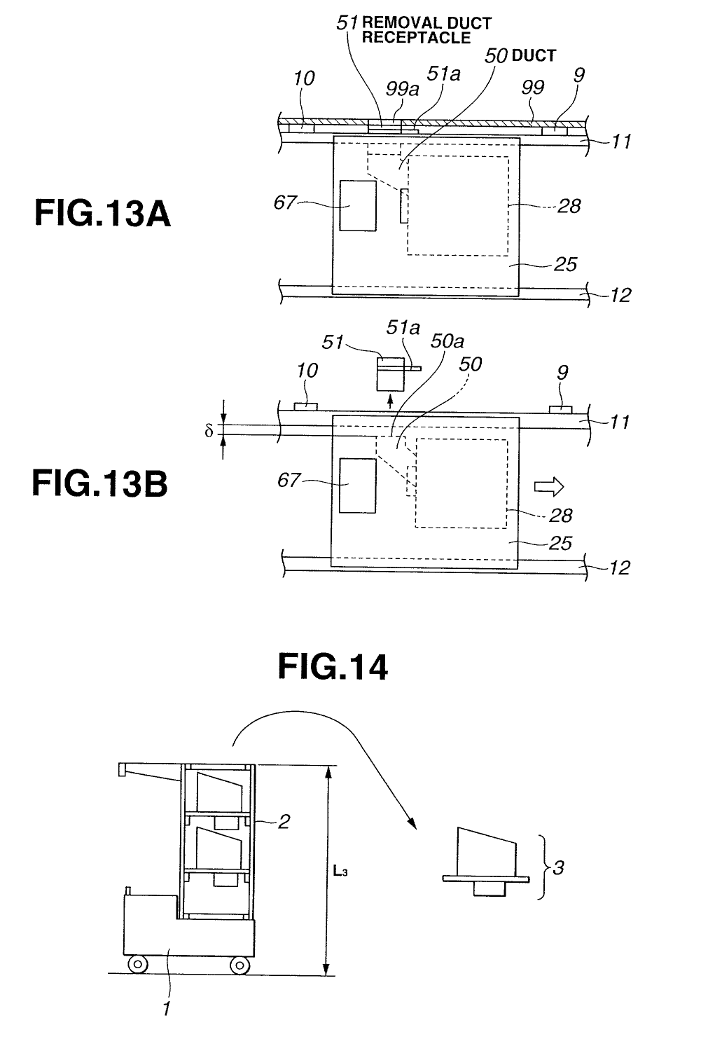

In the base plate 25 of the projection unit 3, a duct 50 for leading the exhaust gas from the projector 28 to the outside of the apparatus is provided, as diagrammed in FIGS. 13A and 13B. In FIGS. 13A and 13B, a case of the projection unit 3 being mounted onto the rail members 11 and 12 is exemplified (with the same applying to the rail members 7 and 8, and to the rail members 13 and 14). One open end of the duct 50 covers an exhaust port in the projector 28, while the other open end engages a duct receptacle 51 secured detachably to a securing member (not shown) in the engine unit 2. The duct receptacle 51 is made freely attachable and detachable to and from the securing member of the engine unit 2, as diagrammed in FIG. 13B, so as not to interfere when the base plate 25 of the projection unit 3 is slidden over the rail members 11 and 12. The duct receptacle 51 is provided with a collar 51a for positioning it with respect to the securing member to which it is mounted. After the base plate 25 of the projection unit 3 has been mounted and secured on the rail members 11 and 12, the way whereby the duct receptacle 51 is secured to the securing member in the engine unit 2 is as diagrammed in FIG. 13A. Provision is made so that the exhaust port of the duct receptacle 51 corresponds to an exhaust port 99a provided in the exterior member 99 of the apparatus main body, and so that cooling air can be exhausted to the outside of the apparatus. The exterior member 99 is deployed so as to cover the outer surface of the vertical beams 9 and 10 of the engine unit 2. Unless the positional relationship between the duct 50 and the duct receptacle 51 is set so that a gap δ occurs between the forward end 50a of the duct 50 and the rail member 11, as diagrammed in FIG. 13B, the sliding action cannot be effected. The duct receptacle 51 has a structure that is elongated to the interior of the engine unit 2 so that, when mounted to the securing member in the engine unit 2, it connects with the forward end 50a of the duct and fills up the gap δ therebetween.

When the projection unit 3 is mounted in the engine unit 2, it is slidden to a prescribed position on the rail members in the engine unit 2, positioning and securing are performed as diagrammed in FIGS. 3 to 5, and, last of all, the duct receptacle 51 is inserted into the securing member in the engine unit 2 and secured so as to connect to the forward end of the duct 50. Conversely, when removing the projection unit 3, the duct receptacle 51 is first removed from the engine unit 2, and then, after releasing the projection unit 3 from the rail members, the entire projection unit 3 is slidden.

Before shipping, in order to minimize the height of the shipping package, the three projection units 3 mounted in the horizontal direction in the uppermost row of the engine unit 2 are first removed, as diagrammed in FIG. 14. At installation time, the projection units 3 may be set in place beginning at the uppermost row in the engine unit 2, or may be placed at either the left or right ends of the rail members 7 and 8 in the uppermost row and then slidden so as to move to the prescribed position.

When packaging for shipment, by removing at least the upper row of projection units 3 (assuming that the screen unit 4 has been removed already), the apparatus main body can be packaged so that height L3 is lower than the height L2 (see FIG. 6A) in which all of the projection units are carried on the apparatus main body, by the height of the projection unit 3 (see FIG. 14). That is, if the screen unit 4 is taken down from the apparatus main body and packaged separately, the apparatus main body can be kept down to the height L3 as described above. Assuming a screen size of 100 inches, the height L1 (see FIG. 6B) will ordinarily be 2.3 to 2.5 m, but the height L3 after removing the screen unit 4 and the uppermost row of projection units 3 can be reduced to 1.7 to 1.9 m. If this height L3 is the shipping height, transporting can be done adequately through an ordinary door having a height of 2 m.

Opening and Closing the Screen Unit:

The opening and closing of the screen unit 4 are next described.

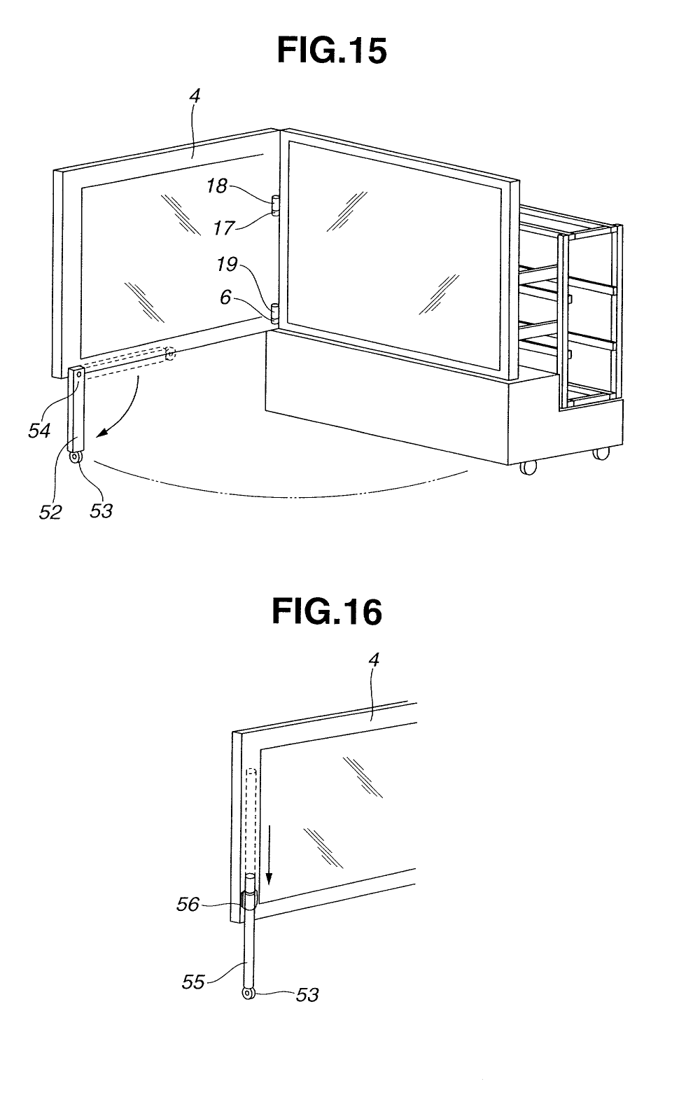

In FIG. 15 is diagrammed one embodiment of a support member used when opening and closing the screen unit 4. The screen unit 4 can be opened so as to swing about the hinges 18 and 19 provided in a side end thereof. When open, the entire weight thereof will rest on the hinges, wherefore damage may easily occur, and there is a danger due to moving of the screen unit 4 during an operation. A support member 52 is therefore deployed on the end opposite the end where the hinges are. The support member 52 is made so that one end thereof can be turned about a fulcrum 54 and the other end turned below the screen unit 4 so as to support the screen unit 4, and a caster 53 is provided at the end that is turned. When the screen unit 4 is mounted on the apparatus main body, the support member 52 is turned toward the screen about the fulcrum 54 and there held and accommodated on the inside of the apparatus. When the screen unit 4 is opened, the support member 52 is turned toward the floor, and secured by a locking mechanism (not shown). Thus, when the screen unit 4 is opened, it opens while the caster 53 rolls over the floor, wherefore it can be opened smoothly and the weight thereof supported, so that the load acting on the hinges 18 and 19 can be reduced. If the caster 53 used is equipped with a locking mechanism for locking the turning thereof, moreover, that can fulfill the role of the locking function when the screen unit 4 is open.

In FIG. 16 is diagrammed another embodiment of a support member used for the screen unit 4. On the side end of the screen opposite the side end where the hinges 18 and 19 are, a support member 55 is provided which is guided by a tubular guide 56. The support member 55 is configured of a pole-shaped material having a circular section, for example, supported by the guide 56 so that it can slide up and down. A caster 53 is provided at the lower end of the support member 55. When the screen unit 4 is mounted on the apparatus main body (with the screen unit 4 closed), the support member 55 is pulled up and accommodated on the inside of the apparatus. When the screen unit 4 is opened, the support member 55 is pulled down, or allowed to fall under its own weight, and, when it reaches the floor, the up and down position thereof is fixed by a locking mechanism (not shown). By opening the screen unit 4 in this condition, because of the caster 53, the screen unit 4 can move smoothly over the floor with the weight thereof supported, and the load on the hinges 18 and 19 can be reduced. If the caster 53 used is equipped with a locking mechanism for locking the turning thereof, moreover, that can fulfill the role of the locking function when the screen unit 4 is open.

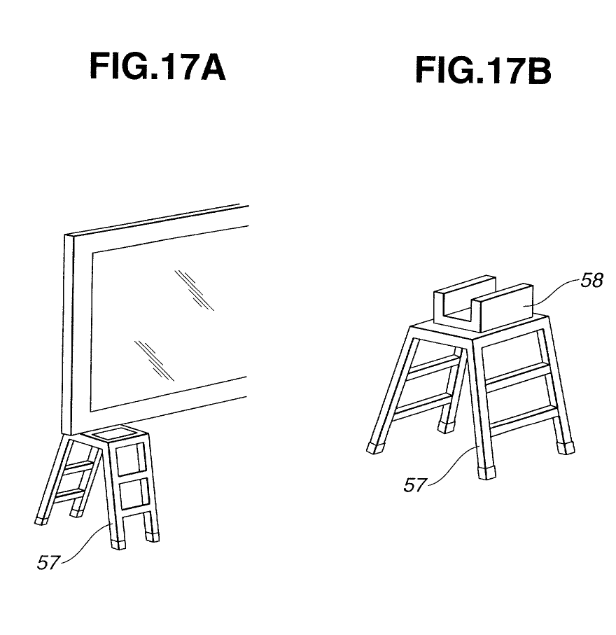

In FIGS. 17A and 17B is diagrammed yet another embodiment of a support mechanism employed when opening the screen unit 4. FIG. 17A represents an example of supporting the turning end of the screen unit 4 on the upper surface of a small step ladder 57, while FIG. 17B represents an example wherein a support member 58 for supporting the turning end of the screen unit 4 is deployed on the upper surface of the small step ladder 57, and support is effected, when the screen unit 4 is opened, the small step ladder 57 is slidden in the screen unit from the turning end of the screen unit 4. The examples diagrammed in FIGS. 17A and 17B are even more effective in preventing movement compared with the caster locking mechanism.

Mechanism for Adjusting Amount of Light at Projected Image Overlapped Portions:

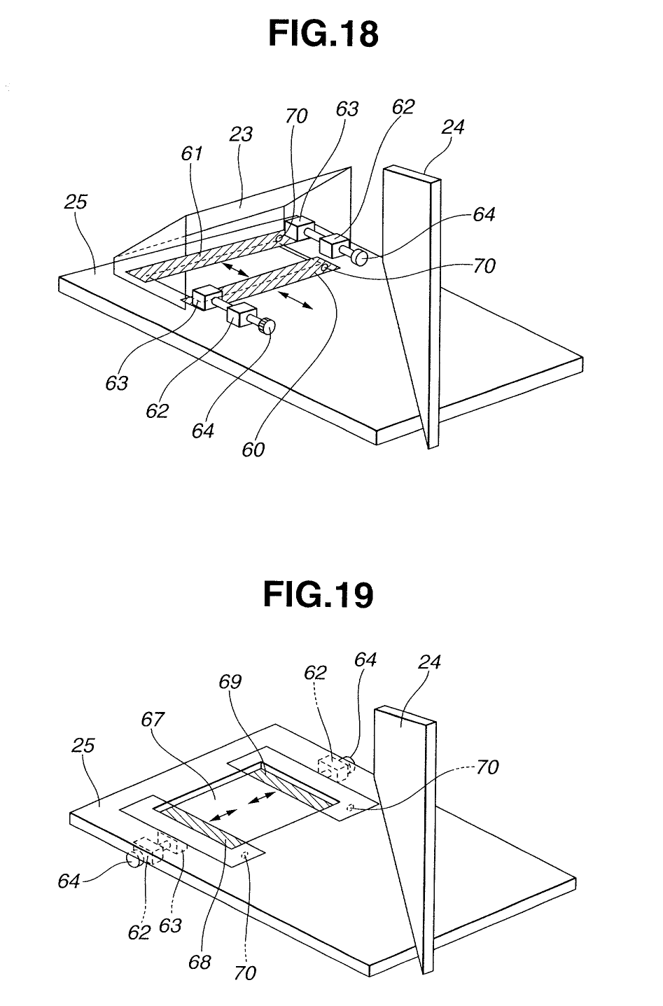

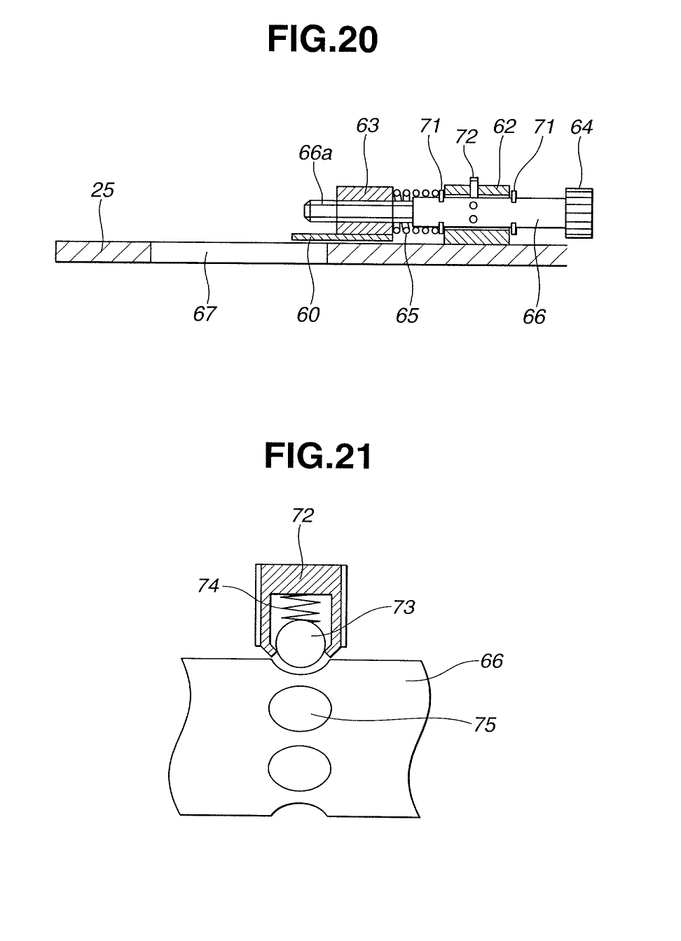

Adjusting the amount of light at the overlapped portions between projected images produced by adjacent projection units in projection units carried on the engine unit 2 is next described, making reference to FIGS. 18 to 21. In FIG. 18 is diagrammed a mechanism for adjusting the amount of light in the overlapped portions above and below a projected image, in FIG. 19 is diagrammed a mechanism for adjusting the amount of light in the overlapped portions to the left and right of a projected image, in FIG. 20 is diagrammed a position varying mechanism for a light amount reduction member, and in FIG. 21 is diagrammed a ball plunger used in a variable position adjustment shaft in [the mechanism diagrammed in] FIG. 20.

As diagrammed in FIGS. 18 and 19, light amount reducing members 60, 61, 68, and 69 for adjusting the amount of light in overlapped areas on the screen unit 4 are attached, so that the positions thereof can be varied, at the periphery of an opening 67 in the base plate 25 for the passage of projected light. The light amount reducing members 60, 61, 68, and 69 are formed of rectangular hard sheet-form material (indicated by crosshatching in FIGS. 18 and 19). The light amount reducing members 60 and 61 are deployed at the periphery of the opening 67 in the base plate 25, on the upper surface of the base plate, as diagrammed in FIG. 18, so that, using the position varying mechanism diagrammed in FIG. 20, the light amount reducing members can be moved over some range in the direction indicated by the arrows in the figure so as to adjust the amount of light above and below the projected image. The light amount reducing members 68 and 69 are deployed at the periphery of the opening 67 in the base plate 25, on the back surface of the base plate, as diagrammed in FIG. 19, so that, using the position varying mechanism diagrammed in FIG. 20, the light amount reducing members can be moved over some range in the direction indicated by the arrows in the figure so as to adjust the amount of light on the left and right of the projected image.

The adjustment mechanism diagrammed in FIG. 20 is used as the position varying mechanism for the light amount reducing members 60, 61, 68, and 69. In FIG. 20, a description is given on the position varying mechanism for the light amount reducing member 60, but the same applies to the position varying mechanisms for the other light amount reducing members 61, 68, and 69.

As diagrammed in FIG. 20, a block 63 having female threads cut therein is secured to the light amount reducing member 60. In the base plate 25, meanwhile, a block 62 is secured, and a shaft 66 is inserted through a through hole in the block 62 in a configuration wherein that shaft 66 is supported so that it can freely turn. At the tip of the shaft 66 are provided male threads 66a that mate with the female threads in the block 63. A thrust stopper 71 such as an E ring is deployed at positions corresponding to both sides of the block 62 in the shaft 66 so that that shaft 66 does not become displaced from the block 62. Between the block 63 and the block 62, a spring 65 is inserted, so that the block 63 and the block 62 are always in a tensioned state, with the screw play pushed in one direction. Also, on the other end of the shaft 66 from the screw threads 66a, a knob 64 is provided to make the shaft 66 easy to turn.

The relationship between the light amount reducing members 60, 61, 68, and 69 is such that the pair of mutually facing members 60 and 61 and the pair of members 69 and 68 are deployed respectively, by pairs, on a same plane, and the respective combinations are deployed on the front and back surfaces of the base plate 25, so that, without a complex configuration being adopted, the front and back pairs of light amount reducing members can be deployed without mutual mechanical interference. By deploying the light amount reducing members on the front and back of the base plate 25, they can be provided in a compact shape.

In the block 62, a ball plunger 72 is deployed, as diagrammed in FIG. 21, in such manner that a ball 73 of the plunger 72 fits into a groove 75 on the shaft 66. The ball 73 is continually acted on by a force pushing it toward the shaft 66 by a spring 74 built into the plunger 72, wherefore a clicking sensation is obtained each time the knob 64 is turned.

The working of the light amount adjustment mechanism in the structure described in the foregoing is now described. In a positional adjustment of the light amount reducing members 60, 61, 68, and 69, projected images on the screen unit 4 are observed and the amounts to advance or retract them are determined. When that is being done, because how many mm will be advanced for each click of the knob 64 has been calculated as a design guaranteed value, the amount of advance or retraction can be finely adjusted according to the number of those clicks.

When the shaft 66 is turned to the left, the position of the shaft 66 will not change because it is thrust-stopped by the block 62, but, because the female threads of the block 63 are mated with the male threads on the shaft 66, the block 63 will be summoned in conjunction with a turning of the shaft 66 to the right, and the light amount reducing member 60 can be retracted from the opening 67. Conversely, if the shaft 66 is turned in the opposite direction, the light amount reducing member 60 can be pushed into the opening 67.

The positions of the light amount reducing members 60, 61, 68, and 69 are maintained by tension of the spring 65, but it is conceivable that a very small amount of positional change will be caused by vibration during shipment, wherefore a hole 70 is provided in each one end of the respective light amount reducing members, as diagrammed in FIGS. 18 and 19, and the light amount reducing members are secured by set screws in screw holes provided in the base plate 25 at positions corresponding to those holes 70.

Based on the present invention, as described in the foregoing, not only the required projection distance can be secured, but also the apparatus can be designed compactly (and, in particular, thinly in the depth dimension).

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A multi-display apparatus comprising:
a projection unit having a projector and a plurality of mirrors for bending projected light from that projector mounted on a same base plate;
a shelved structure for deploying a plurality of said projection units; and
a screen unit for forming projected images from said plurality of projection units and displaying a resulting picture image.

2. The multi-display apparatus according to claim 1, wherein said plurality of mirrors for bending light projected from the projector in said projection unit has reflecting mirrors individually supported so as to be turnable, so that position of and distortion of the projected images can be adjusted for each projection unit.

3. The multi-display apparatus according to claim 1, wherein said projection unit has a projector and a first reflecting mirror deployed on lower side of said base plate, has second and third reflecting mirrors deployed on upper side of said base plate, either said first reflecting mirror or the second reflecting mirror adjusts the image plane in the vertical direction, and said third reflecting mirror adjusts the image plane in the horizontal direction.

4. The multi-display apparatus according to claim 1, wherein said projection unit has a light amount reducing member for reducing the amount of light in the portion of the projected image overlapped by the projected image of an adjacent projection unit.

5. The multi-display apparatus according to claim 1, wherein said light amount reducing member is deployed in said base plate.

6. The multi-display apparatus according to claim 4, wherein said light amount reducing member is deployed in said base plate.

7. The multi-display apparatus according to claim 1, wherein said projection unit is mounted in a structure having a frame comprising vertical beams and horizontal beams, by sliding the projection unit, using the horizontal beams as rail members, and is accurately positioned by being secured so that positioning holes provided in the horizontal beams are aligned with positioning holes provided in said base plate of said projection unit.

8. The multi-display apparatus according to claim 1, wherein the projectors mounted in said projection unit have a projected image adjustment function so that a single projector can be replaced with the compatibility being maintained with respect to the size of projection image plane.

9. The multi-display apparatus according to claim 1, wherein a duct for leading cooling air of said projector to outside of the apparatus is provided in said projection unit, and a part of that duct is deployed to be retractable from said structure so as to avoid colliding with the beams of said structure when said projection unit is slidden for mounting on or removing from said structure.

10. The multi-display apparatus according to claim 6, wherein a duct for leading cooling air of said projector to outside of the apparatus is provided in said projection unit, and a part of that duct is deployed to be retractable from said structure so as to avoid colliding with the beams of said structure when said projection unit is slidden for mounting on or removing from said structure.

11. The multi-display apparatus according to claim 1, wherein the uppermost row of said projection units can be removed from said structure by lifting upward, and said projection units at rows lower than that uppermost row can be removed by sliding in the horizontal direction of said structure.

12. The multi-display apparatus according to claim 6, wherein the uppermost row of said projection units can be removed from said structure by lifting upward, and said projection units at rows lower than that uppermost row can be removed by sliding in the horizontal direction of said structure.

13. The multi-display apparatus according to claim 1, wherein the multi-display apparatus can be packaged with at least the uppermost row of said projection units removed from said structure to enable packaging.

14. The multi-display apparatus according to claim 11, wherein the multi-display apparatus can be packaged with at least the uppermost row of said projection units removed from said structure to enable packaging.

15. The multi-display apparatus according to claim 12, wherein the multi-display apparatus can be packaged with at least the uppermost row of said projection units removed from said structure to enable packaging.

16. A multi-display apparatus comprising:
an engine unit having a shelved structure for deploying a plurality of projection units each having a projector and a plurality of mirrors for bending projected light from that projector mounted on a same base plate;
a screen unit for forming projected images from said plurality of projection units and displaying a picture image; and
a base for defining a positional relationship between said engine unit and said screen unit, and supporting those units;
wherein said engine unit, said screen unit, and said base are capable of being separated from each other.

17. The multi-display apparatus according to claim 16, wherein said engine unit and screen unit are engaged by a positional member for maintaining the positional relationship therebetween.

18. The multi-display apparatus according to claim 16, wherein said screen unit opens and closes with respect to said engine unit, about a fulcrum at one end thereof.

19. The multi-display apparatus according to claim 18, wherein said screen unit has a support member for supporting the own weight on the open side thereof, when opened or closed about the fulcrum at one end thereof.
